(19) United States
(12) Patent Application Publication
(10) Pub. No.: US 2024/0174770 A1
(43) Pub. Date: May 30, 2024

(54) METHOD FOR PREPARING V-TYPE POROUS STARCH

(71) Applicant: Jiangnan University, Wuxi (CN)

(72) Inventors: Xing ZHOU, Wuxi (CN); Xiaoli LIANG, Wuxi (CN); Zhengyu JIN, Wuxi (CN); Ren WANG, Wuxi (CN); Zhengjun XIE, Wuxi (CN); Jianwei ZHAO, Wuxi (CN); Jie LONG, Wuxi (CN); Long CHEN, Wuxi (CN); Chao QIU, Wuxi (CN)

(21) Appl. No.: 18/525,796

(22) Filed: Nov. 30, 2023

(30) Foreign Application Priority Data
Nov. 30, 2022 (CN) 202211522862.1

(51) Int. Cl. C08B 30/12; A23L 29/30

(52) U.S. Cl. CPC C08B 30/12; A23L 29/30

(57) ABSTRACT

A method for preparing V-type porous starch includes: mixing starch and a first ethanol solution in a reaction kettle, adding concentrated hydrochloric acid to the reaction kettle for acidity regulation, and controlling a temperature of a reaction system in the reaction kettle at 80-150° C.; cooling the reaction kettle, and adding a sodium hydroxide solution to the reaction system in the reaction kettle, until a pH of a mixture in the reaction kettle is neutral, to yield a starch solution; and centrifuging the starch solution, washing a collected precipitate with a second ethanol solution, leaching, drying, cooling, and pulverizing, to yield V-type porous starch.

### CROSS-REFERENCE TO RELATED APPLICATIONS

Pursuant to 35 U.S.C. § 119 and the Paris Convention Treaty, this application claims foreign priority to Chinese Patent Application No. 202211522862.1 filed Nov. 30, 2022, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of starch modification, and more particularly to a method for preparing V-type porous starch.

Conventionally, the preparation of V-type porous starch includes two steps: first, to prepare V-type granular starch by high-temperature ethanol method, and on this basis, to use amylase enzyme to hydrolyze V-type granular starch to obtain V-type porous starch. Although the oil absorption rate of the V-type porous starch produced by this method is high, the enzymolysis stage takes as long as 6-12 h. In addition, because the V-type granular starch is soluble in cold water, the enzymolysis needs to be carried out in aqueous-ethanol solution at a certain ethanol concentration in order to maintain its granular morphology, and ethanol itself will denature the enzyme proteins to some degree, which inevitably reduces the enzyme activity. The above two steps lead to high time cost and economic cost, which limits the industrial application of the method to prepare V-type porous starch.

### SUMMARY

The disclosure provides a method for preparing V-type porous starch. The produced porous starch has a significantly increased V-shaped crystalline structure and a large specific surface area and total pore volume, and the water and oil absorption capacity thereof has a significant advantage over the porous starch prepared by traditional methods. The method can be completed in one step and in a shorter time, which greatly improves the preparation efficiency and reduces the cost.

The method for preparing V-type porous starch involves acidolysis in a high-temperature aqueous-ethanol solution; the acidolysis temperature for the high-temperature aqueous-ethanol treatment is about 80-150° C.; and the acidolysis employs hydrochloric acid.

In a class of this embodiment, the V-type relative crystallinity of the V-type porous starch is 15.20-33.00%.

In a class of this embodiment, the concentration of ethanol in the high-temperature aqueous-ethanol solution is 40-70% v/v.

In a class of this embodiment, the mass ratio of the starch to ethanol is between 1:2 and 1:7.

In a class of this embodiment, the starch is corn starch, rice starch, potato starch, wheat starch, barley starch, cassava starch, or a mixture thereof.

In a class of this embodiment, the concentrated hydrochloric acid is added to the reaction kettle so that an acid concentration of the reaction system is 0.01-2%; and an acid hydrolysis time is 5-120 minutes.

Specifically, the method for preparing V-type porous starch comprises:
1) mixing starch and a first ethanol solution in a high pressure reaction kettle, adding concentrated hydrochloric acid to the high pressure reaction kettle for acidity regulation, and controlling a temperature of a reaction system in the high pressure reaction kettle at 80-150° C.;
2) cooling the high pressure reaction kettle, and adding a sodium hydroxide solution to the reaction system in the high pressure reaction kettle, until a pH of a mixture in the high pressure reaction kettle is neutral, to yield a starch solution; and
3) centrifuging the starch solution, washing a collected precipitate with a second ethanol solution, leaching, drying, cooling, and pulverizing, to yield V-type porous starch.

In a class of this embodiment, in 1), reaction conditions of the high pressure reaction kettle are as follows: reaction temperature is 80-150° C., rotation speed is 500-1000 rpm, the reaction temperature is held for 5-120 min, and when the reaction temperature decreases to 40° C., reaction is terminated.

In a class of this embodiment, in 1), the first ethanol solution has a concentration of 40-70%, the starch has a concentration of 10-40%, and in 2), a concentration of the sodium hydroxide solution is 1 mol/L.

In a class of this embodiment, in 1) and 2), the first ethanol solution has a concentration of 40-70%, the starch has a concentration of 12.5-30%.

In a class of this embodiment, in 3), the second ethanol solution has a concentration of 95%; the precipitate is washed thrice; a drying temperature is 100-110° C. for 2-3 hours; and powders obtained through grinding are screened using a 100 mesh sieve.

The disclosure also provides a V-type porous starch prepared according to the abovementioned method.

Further provided is the use of the V-type porous starch in food industry, pharmaceutical preparation industry, agriculture industry, and cosmetics industry.

The following advantages are associated with the method for preparing V-type porous starch of the disclosure:
1. The V-type porous starch is obtained by a one-step method, in which the starch is simultaneously subjected to high-temperature alcohol hydrothermal treatment and acidolysis. The method is easy to practice, with short production time and low-cost, and the adsorption properties of the product are superior.
2. The method involves high-temperature alcohol hydrothermal treatment synchronized with acidolysis, and the product obtained features a high relative crystallinity of V-type in addition to a large specific surface area, large total pore volume, and thus superior adsorption properties. The specific surface area of the V-type porous starch ranges from 11.34-35.40 m²/g, and the total pore volume is from 22.71-160.05×10⁻³ cm³/g, average pore size 14.85-24.95 nm, oil absorption as high as 206.39-343.50%, and water absorption as high as 210.96-460.94%.
3. In the process of high-temperature alcohol-hydrothermal treatment, after the reaction system is heated to a certain temperature, the double helix structure of the starch crystallization zone opens and the released starch chains forms V-type complexes with ethanol, and the A-type crystallization is transformed into a V-type crystallization; at the same time, acidolysis is also being on, and the acidolysis acts on the amorphous zone with a loose structure in the first place; the hydrolysis of the amorphous zone increases the proportion of crystalline zone, and the V-type relative crystallinity thus rises to as high as 15.20-33.00%.
4. Hydrochloric acid functions as a catalyst in the disclosure. V-shaped crystalline structure formed by high-temperature alcohol-hydrothermal treatment has a large number of exposed hydrophilic hydroxyl groups, which is conducive to the reaction of the acid. V-type granular starch is sparser than the original starch in terms of granular structure, and comprises folds and cracks on the surface, which is conducive to the entry of hydrogen ions into the internal granules, and a larger specific surface area increases the efficiency of the reaction; more importantly, compared with enzyme, the reactivity of acid in the alcohol system is unaffected, so the reaction is more efficient. The acid is much inexpensive than enzyme, which further reduces the production cost of V-type porous starch.

### BRIEF DESCRIPTION OF THE DRAWINGS

FIG. 1 shows X-ray diffraction patterns and corresponding V-type or A-type relative crystallinity of V-type porous starch prepared in Example 5 of the disclosure, V-type granular starch, raw starch, and traditional A-type porous starch;

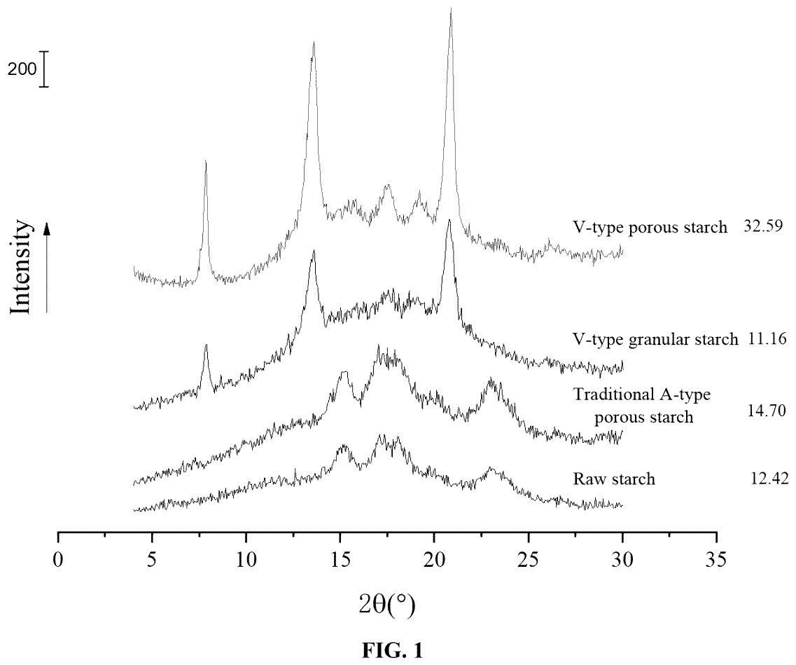

FIG. 2 shows a scanning electron microscopy image of raw starch;

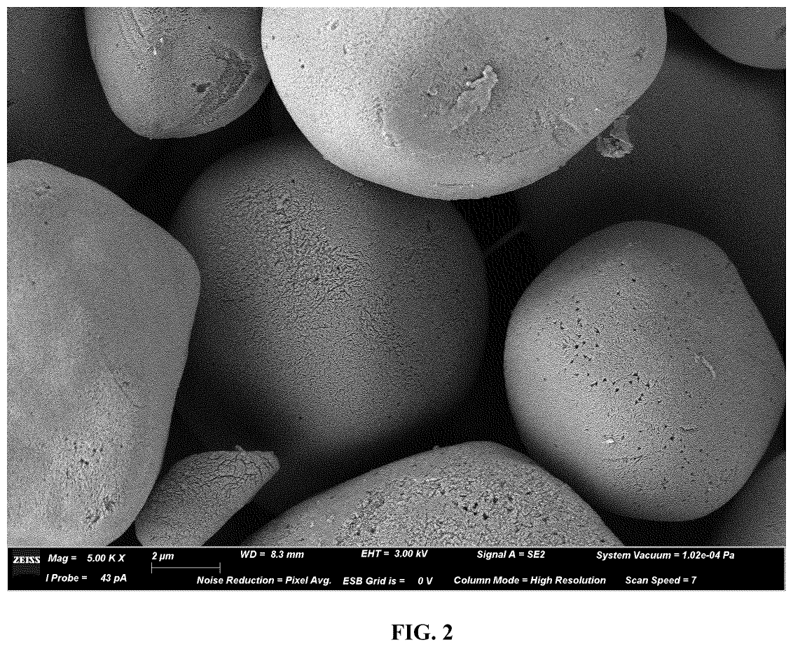

FIG. 3 shows a scanning electron microscopy image of traditional A-type porous starch;

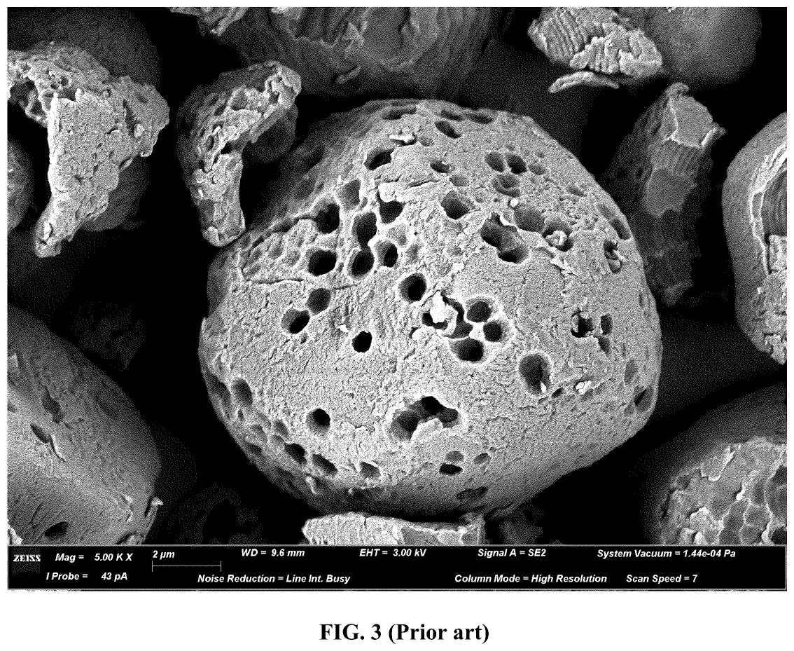

FIG. 4 shows a scanning electron microscopy image of V-type granular starch; and

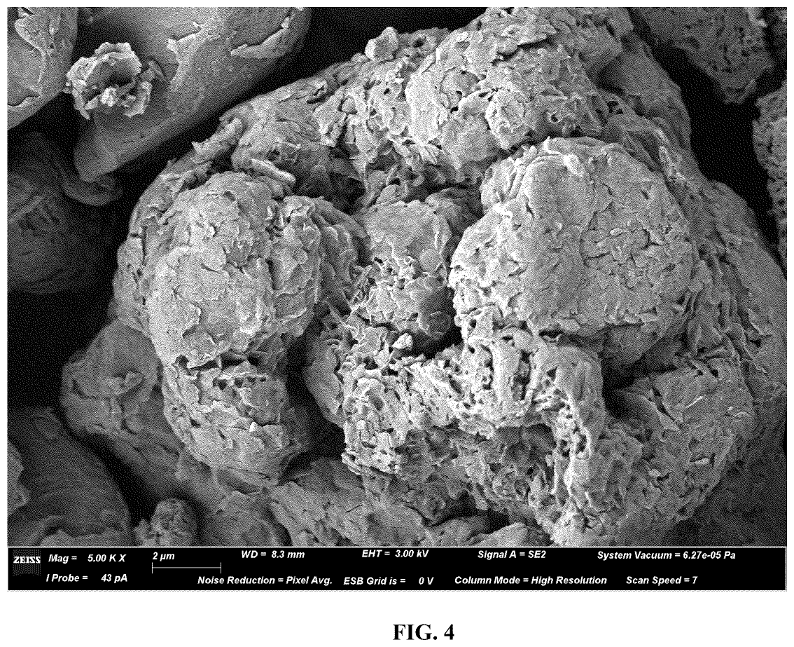

FIG. 5 shows a scanning electron microscopy image of V-type porous starch prepared in Example 5 of the disclosure.

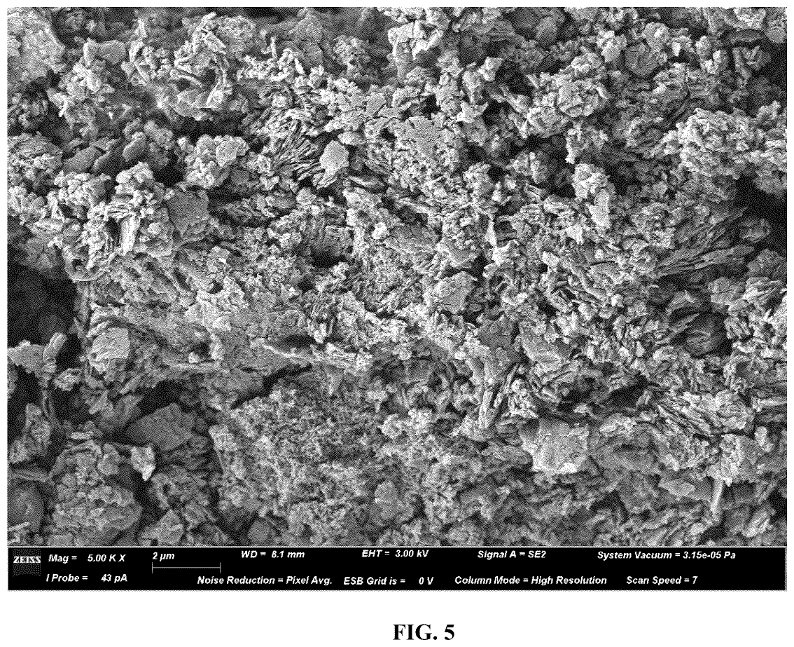

### DETAILED DESCRIPTION

To further illustrate the disclosure, embodiments detailing a method for preparing V-type porous starch are described below. It should be noted that the following embodiments are intended to describe and not to limit the disclosure.

### 1. Measuring Method for Specific Surface Area and Pore Size and Pore Volume

0.1000-0.2000 g of starch sample was weighed and dried at 105° C. for 4 hours in an analyzer ASAP 2020MP equipped with a dilatometer to remove moisture and gas from the sample. Then the sample was placed in high-purity liquid nitrogen at −195.8° C. (nitrogen concentration ≥99.999%). The specific surface areas of five measurement points in the relative pressure range P/P0=0.06-0.3 (P represents nitrogen partial pressure, P0 represents nitrogen saturation vapor pressure at adsorption temperature) were calculated using the Brunauer Emmett Teller (BET) equation. The total pore volume and average pore size of porous materials were measured using the Barrett Joyner Helenda (BJH) analysis model under the condition of P/P0=0.99.

### 2. Measuring Method for Oil Absorption Rate

1.00 g of porous starch (recorded as M1) was placed in a 50 mL centrifuge tube (recorded as M2). 10 mL of soybean oil was added to the centrifuge tube and shaken in a water bath shaker at 50° C. and 200 r/min for 30 minutes. The solution was centrifuged at 3500 r/min and 25° C. for 15 minutes. The supernatant was removed and the mass of the precipitate was recorded as M3. Calculate the oil absorption rate according to the formula: oil absorption rate=(M3−M1−M2)/M1×100%.

### 3. Measuring Method for Water Absorption Rate

1.00 g of porous starch (recorded as M1) was placed in a 50 mL centrifuge tube (recorded as M2). 25 mL of deionized water was added to the centrifuge tube and shaken in a water bath shaker at 50° C. and 200 r/min for 30 minutes. The solution was centrifuged at 3500 r/min and 25° C. for 15 minutes. The supernatant was removed and the mass of the precipitate was recorded as M3. Calculate the water absorption rate according to the formula: water absorption rate=(M3−M1−M2)/M1×100%.

### 4. The Crystal Structure of the Sample was Analyzed Using an X-Ray

diffractometer, with a scanning angle of 4-30° (2θ). The scanning speed is 0.05°/s. The relative crystallinity is calculated using MDI JADE software: the ratio of the area of V-type crystallization characteristic peaks (7.8°, 13.5°, and 20.8°) or A-type crystallization characteristic peaks (15°, 17°, 18°, and 23°) to the total diffraction peak area. The calculation formula is as follows: relative crystallinity (%)=CDA/TDA×100, where CDA represents a peak area of the crystallization characteristic peaks, and TDA represents a total area of all diffraction peaks within the scanning interval.

### Example 1

### Method for Preparing V-type Porous Starch

33 g of corn starch and 167 g of 60% ethanol were mixed in a high pressure reaction kettle, and concentrated hydrochloric acid was added so that the acid concentration of the whole mixture reached 0.2%. Start the high temperature reaction kettle with the following operating parameters: the reaction temperature was 120° C., the rotational speed was 900 r/min, and the reaction time was 5 min. Thereafter, the high temperature reaction kettle was cooled to 40° C., and 1 mol/L sodium hydroxide solution was added to the high temperature reaction kettle to adjust the pH of the reaction solution to be neutral. The reaction solution was centrifuged, washed with 95% ethanol for 2-3 times, and then leached. A precipitate was collected, dried at 100° C. for 3 h, pulverized and passed through a 100-mesh sieve, to yield V-type porous starch. The specific surface area of the V-type porous starch was 30.19 m²/g, the total pore volume was 129.12×10⁻³ cm³/g, the average pore size was 19.85 nm, the oil absorption rate was as high as 302.71%, the water absorption rate was as high as 460.94%, and the V-type relative crystallinity was 26.31%.

### Example 2

### Method for Preparing V-type Porous Starch

25 g of corn starch and 175 g of 40% ethanol were mixed in a high pressure reaction kettle, and concentrated hydrochloric acid was added so that the acid concentration of the whole mixture reached 2%. Start the reaction kettle with the following operating parameters: the reaction temperature was 80° C., the rotational speed was 700 r/min, and the reaction time was 60 min. Thereafter, the reaction kettle was cooled to 40° C., and 1 mol/L sodium hydroxide solution was added to the reaction kettle to adjust the pH of the reaction solution to be neutral. The reaction solution was centrifuged, washed with 95% ethanol for 2-3 times, and then leached. A precipitate was collected, dried at 100° C. for 3 h, pulverized and passed through a 100-mesh sieve, to yield V-type porous starch. The specific surface area of the V-type porous starch was 16.67 m²/g, the total pore volume was 70.18×10⁻³ cm³/g, the average pore size was 19.08 nm, the oil absorption rate was as high as 244.94%, the water absorption rate was as high as 339.09%, and the V-type relative crystallinity was30.97%.

### Example 3

### Method for Preparing V-type Porous Starch

40 g of corn starch and 160 g of 70% ethanol were mixed in a high pressure reaction kettle, and concentrated hydrochloric acid was added so that the acid concentration of the whole mixture reached 0.01%. Start the reaction kettle with the following operating parameters: the reaction temperature was 150° C., the rotational speed was 800 r/min, and the reaction time was 15 min. Thereafter, the reaction kettle was cooled to 40° C. , and 1 mol/L sodium hydroxide solution was added to the reaction kettle to adjust the pH of the reaction solution to be neutral. The reaction solution was centrifuged, washed with 95% ethanol for 2-3 times, and then leached. A precipitate was collected, dried at 100° C. for 3 h, pulverized and passed through a 100-mesh sieve, to yield V-type porous starch. The specific surface area of the V-type porous starch was 11.34 m²/g, the total pore volume was 33.13×10⁻³ cm³/g, the average pore size was 14.85 nm, the oil absorption rate was as high as 206.39%, the water absorption rate was as high as 210.96%, and the V-type relative crystallinity was 19.33%.

### Example 4

### Method for Preparing V-type Porous Starch

66 g of corn starch and 134 g of 40% ethanol were mixed in a high pressure reaction kettle, and concentrated hydrochloric acid was added so that the acid concentration of the whole mixture reached 0.05%. Start the reaction kettle with the following operating parameters: the reaction temperature was 85° C., the rotational speed was 500 r/min, and the reaction time was 120 min. Thereafter, the reaction kettle was cooled to 40° C. , and 1 mol/L sodium hydroxide solution was added to the reaction kettle to adjust the pH of the reaction solution to be neutral. The reaction solution was centrifuged, washed with 95% ethanol for 2-3 times, and then leached. A precipitate was collected, dried at 105° C. for 2.5 h, pulverized and passed through a 100-mesh sieve, to yield V-type porous starch. The specific surface area of the V-type porous starch was 20.83 m²/g, the total pore volume was 69.22×10⁻³ cm³/g, the average pore size was 16.30 nm, the oil absorption rate was as high as 226.49%, the water absorption rate was as high as 344.91%, and the V-type relative crystallinity was 26.95%.

### Example 5

### Method for Preparing V-type Porous Starch

40 g of corn starch and 160 g of 50% ethanol were mixed in a high pressure reaction kettle, and concentrated hydrochloric acid was added so that the acid concentration of the whole mixture reached 1%. Start the reaction kettle with the following operating parameters: the reaction temperature was 100° C. , the rotational speed was 500 r/min, and the reaction time was 30 min. Thereafter, the reaction kettle was cooled to 40° C. , and 1 mol/L sodium hydroxide solution was added to the reaction kettle to adjust the pH of the reaction solution to be neutral. The reaction solution was centrifuged, washed with 95% ethanol for 2-3 times, and then leached. A precipitate was collected, dried at 110° C. for 2 h, pulverized and passed through a 100-mesh sieve, to yield V-type porous starch. The specific surface area of the V-type porous starch was 34.02 m²/g, the total pore volume was 156.86×10⁻³ cm³/g, the average pore size was 23.61 nm, the oil absorption rate was as high as 336.65%, the water absorption rate was as high as 415.98%, and the V-type relative crystallinity was 32.59%.

### Comparison Example

40 g of corn starch and 160 g of 50% ethanol were mixed in a high pressure reaction kettle, and concentrated hydrochloric acid was added so that the acid concentration of the whole mixture reached 4%. Start the reaction kettle with the following operating parameters: the reaction temperature was 100° C., the rotational speed was 500 r/min, and the reaction time was 30 min. The starch was completely hydrolyzed to small molecule sugars and no porous starch was obtained.

It will be obvious to those skilled in the art that changes and modifications may be made, and therefore, the aim in the appended claims is to cover all such changes and modifications.

The invention claimed is:

1. A method for preparing V-type porous starch, comprising:
1) mixing starch and a first ethanol solution in a reaction kettle, adding concentrated hydrochloric acid to the reaction kettle for acidity regulation, and controlling a temperature of a reaction system in the reaction kettle at 80-150° C.;
2) cooling the reaction kettle, and adding a sodium hydroxide solution to the reaction system in the reaction kettle, until a pH of a mixture in the reaction kettle is neutral, to yield a starch solution; and
3) centrifuging the starch solution, washing a collected precipitate with a second ethanol solution, leaching, drying, cooling, and pulverizing, to yield V-type porous starch.

2. The method of claim 1, wherein a concentration of ethanol in the reaction system is 40-70% v/v.

3. The method of claim 1, wherein a mass ratio of the starch to ethanol is between 1:2 and 1:7.

4. The method of claim 1, wherein the starch is corn starch, rice starch, potato starch, wheat starch, barley starch, cassava starch, or a mixture thereof.

5. The method of claim 1, wherein the concentrated hydrochloric acid is added to the reaction kettle so that an acid concentration of the reaction system is 0.01-2%; and an acid hydrolysis time is 5-120 minutes.

6. The method of claim 1, wherein in 1), reaction conditions of the reaction kettle is as follows: reaction temperature is 80-150° C., rotation speed is 500-1000 rpm, the reaction temperature is held for 5-120 min; and when the reaction temperature decreases to 40° C., reaction is terminated.

7. The method of claim 1, wherein in 1), the first ethanol solution has a concentration of 40-70%, the starch has a concentration of 12.5-30%, and in 2), a concentration of the sodium hydroxide solution is 1 mol/L.

8. The method of claim 1, wherein in 3), the second ethanol solution has a concentration of 95%; the precipitate is washed thrice; a drying temperature is 100-110° C. for 2-3 hours; and powders obtained through grinding are screened using a 100 mesh sieve.
